(19) United States
(12) Patent Application Publication
(10) Pub. No.: US 2017/0345393 A1
(43) Pub. Date: Nov. 30, 2017

(54) ELECTRONIC DEVICE AND EYE PROTECTING METHOD THEREFOR

(71) Applicants: Fu Tai Hua Industry (Shenzhen) Co., Ltd., Shenzhen (CN); HON HAI PRECISION INDUSTRY CO., LTD., New Taipei (TW)

(72) Inventors: WEI WU, Shenzhen (CN); CHIEH-YU LEE, New Taipei (TW); HSU-MIN KUO, New Taipei (TW)

(21) Appl. No.: 15/603,436

(22) Filed: May 23, 2017

(30) Foreign Application Priority Data
May 24, 2016 (CN) 201610348028.3

(51) Int. Cl. G09G 5/10; G06T 7/60

(52) U.S. Cl. CPC G09G 5/10; G06T 7/60; G09G 2354/00; G09G 2320/0626; G06T 2207/30201; G09G 2360/144; G09G 2330/027

(57) ABSTRACT

An eye protecting method in an electronic device with storage device determines eyesight of a user who is using an electronic device, acquires light intensity of the environment, and distance of eyes of a user from the device, and applies a preferred display brightness value which is associated with the readings. The method may also cause display of warnings to the user as to eye-distance from the device and current time period spent watching the device.

### CROSS-REFERENCE TO RELATED APPLICATIONS

This application claims priority to Chinese Patent Application No. 201610348028.3 filed on May 24, 2016, the contents of which are incorporated by reference herein.

### FIELD

The subject matter herein generally relates to display control technology, and particularly to an electronic device and an eye protecting method for the device.

### BACKGROUND

Smart electronic devices like smart phones or personal computers are widely used, many users usually spend a lot of time watching a display screen of the electronic device, which can lead to eyesight damage.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an exemplary embodiment of an electronic device.

FIG. 2-3 illustrates a flowchart of an exemplary embodiment of an eye protecting method used in the electronic device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

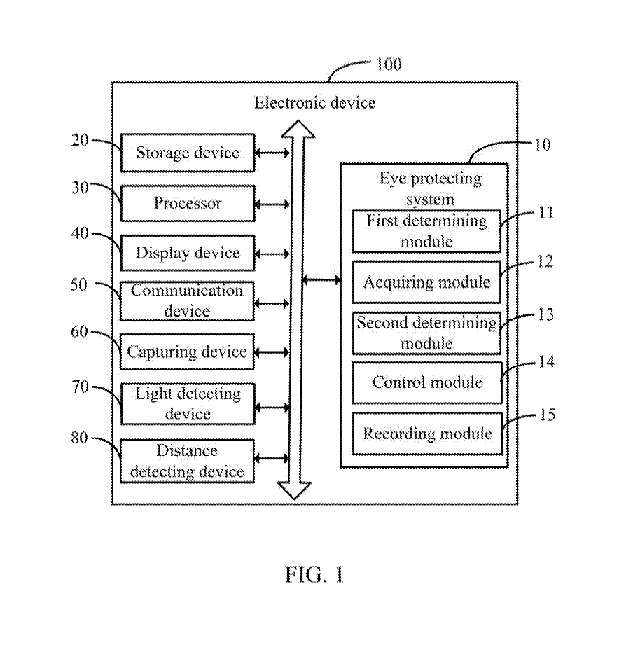

FIG. 1 illustrates an exemplary embodiment of an electronic device 1. An eye protecting system 10 is run in the electronic device 1. The eye protecting system 10 is used for adjusting display brightness of the electronic device 1 according to eyesight of a user using the electronic device 1 and light intensity of the environment of the electronic device 1. The eye protecting system 10 monitors behaviors of the user when using the electronic device 1, and guides the user to use the electronic device 1 to reduce likelihood of eye damage.

The electronic device 1 includes, but is not limited to, a processor 20, a storage device 30, a display device 40, a communication device 50, a capturing device 60, a light detecting device 70, and a distance detecting device 80. In at least one exemplary embodiment, the electronic device 1 can be a smart phone, a personal computer, or a personal digital assistant. FIG. 1 illustrates only one example of the electronic device 1, other examples can include more or fewer components than as illustrated, or have a different configuration of the various components in other embodiments.

In at least one exemplary embodiment, the storage device 30 can include various types of non-transitory computer-readable storage mediums. For example, the storage device 30 can be an internal storage system, such as a flash memory, a random access memory (RAM) for temporary storage of information, and/or a read-only memory (ROM) for permanent storage of information. The storage device 30 can also be an external storage system, such as a hard disk, a storage card, or a data storage medium. The processor 20 can be a central processing unit (CPU), a microprocessor, or other data processor chip that performs functions of the electronic device 1.

In at least one exemplary embodiment, the display device 40 can be a touch screen. The display device 40 can display a user interface of the electronic device 1. Brightness of the display device 40 can be changed.

In at least one exemplary embodiment, the communication device 50 can be a WiFi device or an Internet device. The communication device 50 is used for communicating with other electronic devices.

In at least one exemplary embodiment, the capturing device 60 can be a camera.

The capturing device 60 is arranged at an appropriate position of the electronic device 1. For example, the capturing device 60 is arranged right above the display device 40. The capturing device 60 is used for capturing images of the user when the user watches the display device 40, such as facial images of the user.

In at least one exemplary embodiment, the light detecting device 70 can be a light sensor. The light detecting device 70 is used for detecting ambient light intensity.

In at least one exemplary embodiment, the distance detecting device 80 can be an infrared sensor. The distance detecting device 80 is used for detecting a distance between the user and the electronic device 1. In the exemplary embodiment, the distance detecting device 80 detects a distance between the eyes of the user and the electronic device 1. In other exemplary embodiments, the distance detecting device 80 can also be an ultrasonic wave sensor.

As illustrated in FIG. 1, the eye protecting system 10 includes a first determining module 11, an acquiring module 12, a control module 13, a second determining module 14, and a recording module 15. The modules 11-15 can be collections of software instructions stored in the storage device 30 of the electronic device 1 and executed by the processor 20. The modules 11-15 also can include functionality represented as hardware or integrated circuits, or as software and hardware combinations, such as a special-purpose processor or a general-purpose processor with special-purpose firmware.

The first determining module 11 is used to determine the eyesight of the user who is using the electronic device 1.

In at least one exemplary embodiment, the storage device 30 stores identification information of the users and the eyesight information of each user associated with the identification information.

In a first exemplary embodiment, the identification information can be facial images. When the user is using the electronic device 1, the acquiring module 12 controls the capturing device 60 to capture the facial image of the user. When the facial image of the user is verified, the first determining module 11 acquires the eyesight information associated with the verified facial image.

In a second exemplary embodiment, the identification information can be fingerprint information. The acquiring module 12 acquires the fingerprint information of the user through a fingerprint acquiring device (not shown). When the fingerprint information of the user is verified, the first determining module 11 acquires the eyesight information associated with the verified fingerprint information.

In a third exemplary embodiment, the acquiring module 12 is used to acquire an eye image from the facial image captured by the capturing device 60. The first determining module 11 can determine the eyesight of the user according to the acquired eye image of the user. In detail, the first determining module 11 recognizes a pupil area in the eye image, calculates the pupil size, and determines the eyesight according to the pupil size.

The acquiring module 12 is further used to acquire the light intensity of the current environment of the electronic device 1 by the light detecting device 70.

In at least one exemplary embodiment, the storage device 70 further stores a relationship table recording relationship among a number of light intensity values, the eyesight of the user, and display brightness values of the display device 40. The acquiring module 12 acquires a display brightness value, according to the eyesight of the user, the current light intensity detected by the light detecting device 70, and the relationship among the light intensity values, the eyesight of the user, and the display brightness values of the display device 40.

The control module 13 is used to adjust the display brightness of the display device 40 to the acquired display brightness value.

The acquiring module 12 is further used to acquire the distance between the eyes of the user and the electronic device 1 by the distance detecting device 80 every predetermined time period.

In at least one exemplary embodiment, the distance detecting device 80 transmits infrared rays to detect the user. When the infrared rays reach the user who is using the electronic device 1, the infrared rays are reflected, then the distance detecting device 80 receives the reflected infrared rays. According to transmission speed of the infrared rays and time interval between transmission and return reflection, the distance detecting device 80 calculates the distance between the eyes of the user and the electronic device 1. In at least one exemplary embodiment, the predetermined time period can be five seconds. In other exemplary embodiments, the predetermined time period can be any other value.

The second determining module 14 is used to determine whether the distance between the eyes of the user and the electronic device 1 is less than a predetermined distance.

When the second determining module 14 determines that the distance between the eyes of the user and the electronic device 1 is less than the predetermined distance, the control module 13 is further used to control the electronic device 1 to output a message to prompt the user to consider the distance to the electronic device 1, and may warn the user that the distance is too close.

In other exemplary embodiments, when the second determining module 14 determines that the distance between the eyes of the user and the electronic device 1 is less than the predetermined distance, the control module 13 may turn off the display device 40.

The recording module 15 is used to record current usage of the electronic device 1. The second determining module 14 is further used to determine whether the user can continue using the electronic device 1 according to the current usage of the electronic device 1.

When the second determining module 14 determines that the user should no longer use the electronic device 1, the control module 13 controls the electronic device 1 to output a message to prompt the user to stop using the electronic device 1.

In other exemplary embodiments, when the second determining module 14 determines that the user should no longer use the electronic device 1, the control module 13 may shut down the electronic device 1.

In at least one exemplary embodiment, the current usage of the electronic device 1 includes, but is not limited to, a duration of using the electronic device 1, a duration of using a designated application, and a duration or number of times that the distance between the eyes of the user and the electronic device 1 is less than the predetermined distance.

In at least one exemplary embodiment, the control module 14 is further used to send the current usage of the electronic device 1 to a mobile terminal which communicates with the electronic device 1 by the communication device 50. Such mobile terminal may be in the possession of a member of the user's family for example.

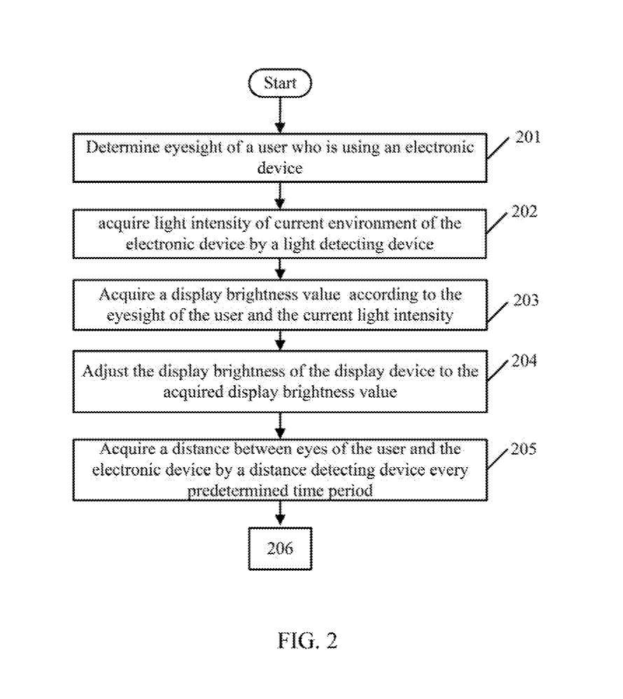

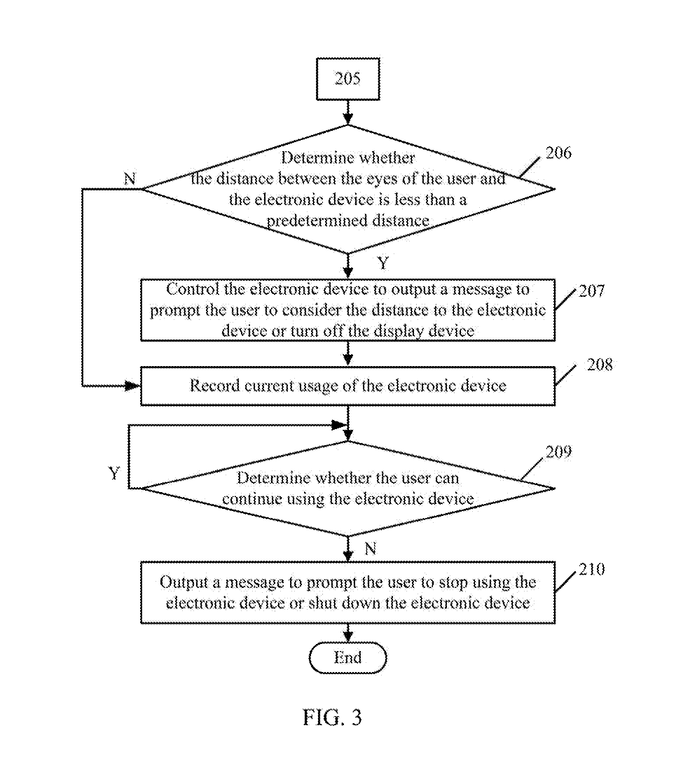

FIGS. 2-3 illustrate a flowchart of an exemplary embodiment of a method for controlling an electronic device to sleep. The method is provided by way of example, as there are a variety of ways to carry out the method. The method described below can be carried out using the configurations illustrated in FIG. 1, for example, and various elements of these figures are referenced in explaining the example method. Each block shown in FIGS. 2-3 represent one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 201.

At block 201, a first determining module determines eyesight of a user who is using an electronic device 1.

At block 202, an acquiring module acquires light intensity of the current environment of the electronic device 1 by a light detecting device.

At block 203, the acquiring module further acquires a display brightness value, according to the eyesight of the user, the current light intensity, and the relationship among the light intensity values, the eyesight of the user, and the display brightness values of a display device.

At block 204, a control module adjusts the display brightness of the display device to the acquired display brightness value.

At block 205, the acquiring module further acquires a distance between the eyes of the user and the electronic device by the distance detecting device every predetermined time period.

At block 206, a second determining module determines whether the distance between the eyes of the user and the electronic device is less than a predetermined distance. If the distance between the eyes of the user and the electronic device is less than the predetermined distance, the process jumps to block 207. If the distance between the eyes of the user and the electronic device 1 is greater than or equal to the predetermined distance, the process jumps to block 208.

At block 207, the control module further controls the electronic device to output a message to prompt the user to consider the distance to the electronic device or turn off the display device.

At block 208, a recording module records current usage of the electronic device.

At block 209, the second determining module further determine whether the user can continue using the electronic device according to the current usage of the electronic device 1. If the user cannot continue using the electronic device, the process jumps to block 210. If the user can continue using the electronic device 1, the process returns to block 208.

At block 210, the control module controls the electronic device to output a message to prompt the user to stop using the electronic device or shuts down the electronic device.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
at least one processor;
a display device electrically coupled to the processor; and
a storage device electrically coupled to the processor and storing instructions for execution by the processor to cause the processor to:
determine eyesight of a user who is using the electronic device;
acquire light intensity of the current environment of the electronic device by a light detecting device;
acquire a display brightness value, according to the eyesight of the user, the current light intensity, and a relationship among the light intensity values, the eyesight of the user, and the display brightness values of the display device; and
adjust the display brightness of the display device to the acquired display brightness value.

2. The electronic device according to claim 1, wherein the at least one processor is further caused to:
control a capturing device to capture a facial image of the user;
identify the captured facial image of the user; and
acquire, when the facial image of the user is verified, the eyesight associated with the verified facial image.

3. The electronic device according to claim 1, wherein the at least one processor is further caused to:
acquire fingerprint information of the user by a fingerprint acquiring device;
identify the acquired fingerprint information of the user; and
acquire, when the fingerprint information of the user is verified, the eyesight associated with the verified fingerprint information.

4. The electronic device according to claim 2, wherein the at least one processor is further caused to:
acquire an eye image from the facial image captured by the capturing device;
recognize a pupil area in the eye image;
calculate the pupil size; and
determine the eyesight according to the pupil size.

5. The electronic device according to claim 1, wherein the at least one processor is further caused to:
acquire a distance between the eyes of the user and the electronic device by a distance detecting device every predetermined time period;
determine whether the distance between the eyes of the user and the electronic device is less than a predetermined distance; and
control, when determining that the distance between the eyes of the user and the electronic device is less than the predetermined distance, the electronic device to output a message to prompt the user to consider the distance to the electronic device or turn off the display device.

6. The electronic device according to claim 1, wherein the at least one processor is further caused to:
record current usage of the electronic device;
determine whether the user continues using the electronic device according to the current usage of the electronic device; and
control, when determining that the user does not continue using the electronic device, the electronic device to output a message to prompt the user to stop using the electronic device.

7. The electronic device according to claim 6, wherein the usage of the electronic device comprises a duration of using the electronic device, a duration of using a designated application, and a duration or plurality of times that the distance between the eyes of the user and the electronic device is less than the predetermined distance.

8. An eye protecting method comprising:
determining eyesight of a user who is using an electronic device;
acquiring light intensity of the current environment of the electronic device by a light detecting device;
acquiring a display brightness value, according to the eyesight of the user, the current light intensity, and a relationship among the light intensity values, the eyesight of the user, and the display brightness values of a display device; and
adjusting the display brightness of the display device to the acquired display brightness value.

9. The eye protecting method according to claim 8, further comprising:
controlling a capturing device to capture a facial image of the user;
identifying the captured facial image of the user; and
acquiring the eyesight associated with the verified facial image when the facial image of the user is verified.

10. The eye protecting method according to claim 8, further comprising:
acquiring fingerprint information of the user by a fingerprint acquiring device;
identifying the acquired fingerprint information of the user; and
acquiring the eyesight associated with the verified fingerprint information when the fingerprint information of the user is verified.

11. The eye protecting method according to claim 9, further comprising:
acquiring an eye image from the facial image captured by the capturing device;
recognizing a pupil area in the eye image;
calculating the pupil size; and
determining the eyesight according to the pupil size.

12. The eye protecting method according to claim 8, further comprising:
acquiring a distance between the eyes of the user and the electronic device by a distance detecting device every predetermined time period;
determining whether the distance between the eyes of the user and the electronic device is less than a predetermined distance; and
controlling the electronic device to output a message to prompt the user to consider the distance to the electronic device or turn off the display device when determining that the distance between the eyes of the user and the electronic device is less than the predetermined distance.

13. The eye protecting method according to claim 8, further comprising:
recording current usage of the electronic device;
determining whether the user continues using the electronic device according to the current usage of the electronic device; and
controlling the electronic device to output a message to prompt the user to stop using the electronic device when determining that the user does not continue using the electronic device.

14. The eye protecting method according to claim 13, wherein the usage of the electronic device comprises a duration of using the electronic device, a duration of using a designated application, and a duration or plurality of times that the distance between the eyes of the user and the electronic device is less than the predetermined distance.
